(19) United States
(12) Patent Application Publication
(10) Pub. No.: US 2025/0238452 A1
(43) Pub. Date: Jul. 24, 2025

(54) COMPUTER-IMPLEMENTED METHODS AND SYSTEMS FOR PRODUCING A RECOMMENDED CONTEXTUAL RESPONSE OUTPUT

(71) Applicant: Armin Ellis, Cheyenne, WY (US)

(72) Inventor: Armin Ellis, Cheyenne, WY (US)

(21) Appl. No.: 18/418,287

(22) Filed: Jan. 21, 2024

(51) Int. Cl. G06F 16/335; G06F 3/14; G06F 8/61; G10L 13/08

(52) U.S. Cl. CPC G06F 16/335; G06F 3/14; G06F 8/61; G10L 13/08

(57) ABSTRACT

According to an aspect of the present invention, there is provided a computer-implemented method for producing a recommended contextual response output, comprising: providing a mobile device; installing a native mobile application on the mobile device; running the native application on the mobile device; programming a plurality of preprogrammed phrases in the native mobile application; providing preset parameters for recommending one or more of the preprogrammed phrases; and providing an output for the preprogrammed phrases to be output from the mobile device according to the preset parameters.

### BACKGROUND

Prior art sentence completion schemes apply information retrieval techniques to find a suitable sentence completion in response to user entered text. Several methods generally focus on completing sentences considering context of a document. Other work has explored phrase prediction, where phrases need not necessarily end sentences. Related email-based techniques suggest several different short replies to entire email messages. In this case, the user simply selects one of the suggested automated replies in its entirety and then either sends that reply or manually edits the selected automated reply prior to sending that reply.

One prior art reference, US20180101599, discloses various techniques for presenting a user with personalized context-based multi-word text completion suggestions via a user interface. The multi-word text completion suggestions are updated in real-time as the user types and/or selects one or more words of the completion suggestions. The Interactive Text Completion System applies a language model in combination with a document context to generate the completion suggestions. In various implementations, the language model is generated from a store of prior documents created or edited by the user.

However, methods and systems related to recommending responses to live written or audio transmissions are desirable and convenient, accurate systems and methods are lacking in the prior art.

### SUMMARY OF INVENTION

According to an aspect of the present invention, there is provided a computer-implemented method for producing a recommended response output, comprising: providing a mobile device; installing a native mobile application on the mobile device; running the native application on the mobile device; programming a plurality of preprogrammed phrases in the native mobile application; providing preset parameters for recommending one or more of the preprogrammed phrases; and providing an output for the preprogrammed phrases to be output from the mobile device according to the preset parameters.

According to another aspect of the present invention, there is provided a system for producing a recommended response to be spoken by an operator or to be synthesized by a machine as output, comprising: a mobile device; a native mobile application running on the mobile device; a database associated with the native mobile application containing a plurality of preprogrammed phrases; a database associated with the native mobile application containing preset parameters for recommending one or more of the preprogrammed phrases; and an output device for the preprogrammed phrases to be output from the mobile device according to the preset parameters.

According to yet another aspect of the present invention, there is provided a computer-readable medium having instructions stored thereon that, when executed by computer processing, cause operations comprising: installing a native mobile application on a mobile device; running the native mobile application on the mobile device; programming a plurality of preprogrammed phrases in the native mobile application; providing preset parameters for recommending one or more of the preprogrammed phrases; and providing an output for the preprogrammed phrases to be output from the mobile device according to the preset parameters.

### BRIEF DESCRIPTION OF THE DRAWINGS

FIG. 1 illustrates an embodiment of the present invention running on a mobile device.

### DETAILED DESCRIPTION

A pilot onboard an aircraft may transmit a voice communication that includes the aircraft's call sign to an air traffic controller. Frequently an air traffic controller may communicate verbally an instruction or a request for a pilot to ascend or descend to a particular altitude using a call sign associated with the aircraft of the pilot, and the pilot is tasked with composing a response while also managing a host of other piloting tasks. The present invention provides systems and methods to ease the burden of responding for the pilot.

Embodiments of the present invention can display recommended words, phrases, sentences and the like for a pilot to verbalize in communications, e.g., with air traffic control. Presenting recommendations for a pilot's speech can considerably lighten the mental strain on a pilot, improving the safety of aviation.

Other embodiments of the present invention can directly synthesize speech output and produce the sounds using an associated speaker. Yet other embodiments can directly provide the equivalent speech output in a variety of digital audio formats.

Embodiments of the present invention are useful in a wide variety of contexts. Drivers of ground transportation vehicles, captains of ships, and are just some of the many potential users of the technology disclosed herein. Wherever a user is under mental strain and would benefit from recommendations on words, phrases, or other types of responses to be said, the present invention is of substantial utility.

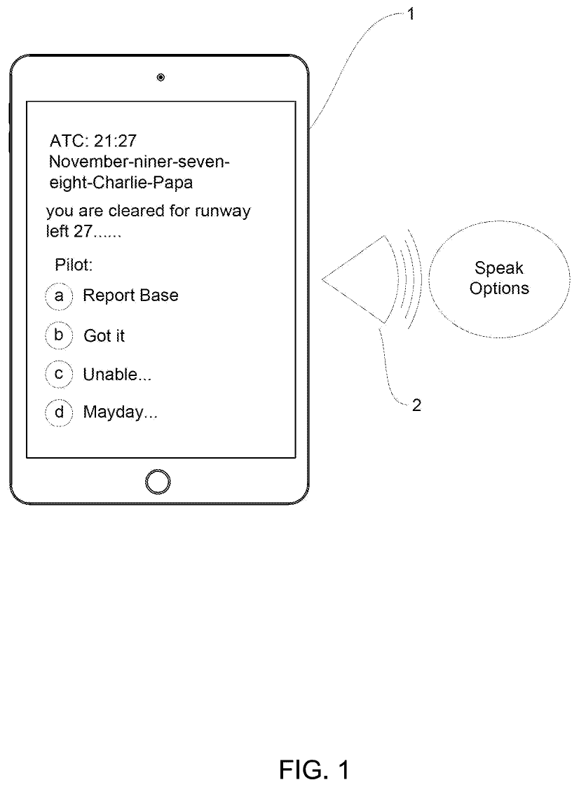

FIG. 1 illustrates an embodiment of the present invention running on a mobile device.

Mobile device 1 is configured to run the native mobile application according to embodiments of the present invention. The application can display an example communication from air traffic control to the pilot of an aircraft, “November-niner-seven-eight-Charlie-Papa. Clear for take off on runway 27 Left”, where November-niner-seven-eight-Charlie-Papa is a call sign for the an aircraft registered (having a tail number) as N978CP. The pilot can then be presented one or more recommendations for a response to the air traffic controller.

Speaker 2 is a means for outputting the recommended speech in some embodiments. It may be a requirement in certain situations such as onboard an aircraft for a pilot to verbalize the recommended words using the pilot's own voice rather than a synthetic voice of the device, where synthetic voice is only an option if permitted by local laws.

The recommendations for the user to speak can be provided according to situational factors perceived by the native mobile application. For example, the native mobile application may detect rapid changes in altitude, for example, that indicate a mayday situation, and recommend that a pilot user say the word mayday. Mayday is an emergency phrase used internationally as a distress signal in verbal radio communications. Mayday is used to signal a life-threatening emergency affecting an aircraft.

The recommendations for the user to speak can be provided according to communications received or other inputs from ATC and other aircraft.

While aviation is one possible application for embodiments of the present invention, there are many other circumstances in which the present invention is useful, including but not limited to maritime, ground transportation, industrial environments, and construction.

Here are the steps according to an embodiment of the present invention.

Step one is installing a native mobile application according to an embodiment on a mobile device. The native mobile application can be downloaded, for example, from an app store. Step two is running the native mobile application on the mobile device.

Step three is programming a plurality of preprogrammed phrases in the native mobile application. The preprogrammed phrases can be specific to the context in which the application is being used. For example, if the application is going to be used by a pilot onboard aircrafts, the preprogrammed phrases could be call signs for the aircrafts on which the pilot flies, and standard aviation terms like mayday.

Step four is providing preset parameters for recommending one or more of the preprogrammed phrases. Parameters could be particular locations; for example, parameters corresponding with points on standard approaches to airports known as standard terminal arrival (STAR), published routings to be followed by aircraft on an instrument flight rules (IFR) flight plan just before reaching a destination airport, can be stored in the mobile device and recommended words for a pilot to say at each point on the STAR can be displayed based on the parameters. A STAR can change depending on the weather and the runway in use, and the native mobile application can alter the recommended speech parameters based on received information about a STAR. STARs can also be used for visual approaches, in which case they refer to landmarks visible on the ground or other visual reference points, instead of waypoints or radio navigation aids.

The following are example transmissions from ATC and suggested responses in embodiments.

### Example ATC Transmission 1:

“November niner seven eight Charlie Papa, extend downwind by 2 miles”
A. Extending downwind two miles, November niner seven eight Charlie Papa
B. Unable
C. Mayday

### Example ATC Transmission 2:

“November niner seven eight Charlie Papa, look out for Cessna Citation in pattern”
A. Traffic in sight, November niner seven eight Charlie Papa
B. Searching for traffic.
C. Mayday

### Example ATC Transmission 3:

“S even eight Charlie Papa, you are cleared to land on runway 27. Wind is 5 knots from 27”
A. Cleared for runway 27, S even eight Charlie Papa
B. Go around, S even eight Charlie Papa
C. Unable
D. Mayday

The following are examples of fresh communications not prompted by ATC communications.

### Entering New Airspace:

A. ABC Approach November niner seven eight Charlie Papa, 8 miles to the north, full stop.
B. ABC Approach November niner seven eight Charlie Papa, 8 miles to the north, permission to enter class B.
C. ABC Approach November niner seven eight Charlie Papa, 8 miles to the north, requesting Special VFR
D. ABC Approach November niner seven eight Charlie Papa, 8 miles to the north, flight following.
E. Mayday

Having thus described a few particular embodiments of the invention, various alterations, modifications, and improvements will readily occur to those skilled in the art. Such alterations, modifications, and improvements are intended to be part of this description though not expressly stated herein, and are intended to be within the spirit and scope of the invention. Accordingly, the foregoing description is by way of example only of several of many potential embodiments, and not limiting.

What is claimed is:

1. A computer-implemented method for producing a recommended speech output, comprising:
providing a mobile device;
installing a mobile application on the mobile device;
running the native application on the mobile device;
displaying a communication from air traffic control to the pilot of an aircraft;
storing preset parameters for recommending one or more preprogrammed phrases, wherein parameters correspond with communications received from air traffic control (ATC) and other aircraft,
storing preprogrammed phrases, wherein the preprogrammed phrases are recommended standard aviation terms for a pilot to say; and
providing an output for the preprogrammed phrases that includes the aircraft's call sign to be output from the mobile device according to the preset parameters.

2. The method of claim 1, wherein the phrases to be output are displayed as recommended text for a user to vocalize on a screen associated with the mobile device.

3. The method of claim 1, wherein the phrases to be output are output as audio via a speaker.

4. The method of claim 1, wherein the phrases are standard phrases used in aviation or other fields of application requiring structured or formal language or combinations to form phrases.

5. The method of claim 2, wherein the mobile application detects rapid changes in altitude that indicate a mayday situation, and recommends that a pilot user say the word mayday as part of a mayday call.

6. The method of claim 1, wherein the phrases to be output are output in digital form.

7. The method of claim 1, wherein at least one of the preset parameters relates to a geographic location.

8. The method of claim 1, wherein at least one of the preset parameters relates to an altitude.

9. The method of claim 1, wherein at least one of the preset parameters relates to an airspeed.

10. The method of claim 1, wherein the preprogrammed phrases include two or more vessel callsigns.

11. A system for producing a recommended speech output, comprising:
a mobile device;
a mobile application running on the mobile device;
a database associated with the mobile application containing a plurality of preprogrammed phrases wherein the preprogrammed phrases are recommended words for a pilot to say at each point on the standard terminal arrival (STAR);
a database associated with the mobile application containing preset parameters for recommending one or more of the preprogrammed phrases, wherein parameters correspond with points on standard approaches to airports known as standard terminal arrival (STAR) published routings to be followed by aircraft on an instrument flight rules (IFR) flight plan just before reaching a destination airport,
and
an output device for the preprogrammed phrases to be output from the mobile device according to the preset parameters.

12. The system of claim 11, further comprising a headset.

13. The system of claim 11, wherein the output device is a display.

14. The system of claim 11, wherein the output device is a speaker.

15. The system of claim 11, further comprising a transponder for sending and/or receiving radio frequency communications.

16. The system of claim 15, wherein the transponder is a transponder on an aircraft.

17. The system of claim 11, further comprising one or more of an altimeter and an airspeed indicator.

18. A computer-readable medium having instructions stored thereon that, when executed by computer processing, cause operations comprising:
installing a mobile application on a mobile device;
running the mobile application on the mobile device;
programming a plurality of preprogrammed phrases in the native mobile application, wherein the preprogrammed phrases are recommended words for a pilot to say at each point on the standard terminal arrival (STAR);
providing preset parameters for recommending one or more of the preprogrammed phrases, wherein parameters correspond with points on standard approaches to airports known as standard terminal arrival (STAR) published routings to be followed by aircraft on an instrument flight rules (IFR) flight plan just before reaching a destination airport; and
providing an output including the aircraft's call sign for the preprogrammed phrases to be output from the mobile device according to the preset parameters.

19. The computer-readable medium according to claim 18, further comprising a database storing one or more vessel call signs.

20. The computer-readable medium according to claim 18, wherein the computer-readable medium contains instructions to block other operations on the mobile device while a vehicle is in motion.
